(19) United States
(12) Patent Application Publication
(10) Pub. No.: US 2004/0188308 A1
(43) Pub. Date: Sep. 30, 2004

(54) Propane gas tank carrier and storage apparatus

(76) Inventor: Shawn P. Mulligan, Sonoma, CA (US)

Correspondence Address: JOHNSON & STAINBROOK, LLP, 3558 ROUND BARN BLVD., SUITE 203, SANTA ROSA, CA, 95403, US

(21) Appl. No.: 10/811,582

(22) Filed: Mar. 29, 2004

Related U.S. Application Data
(60) Provisional application No. 60/459,236, filed on Mar. 29, 2003.

(51) Int. Cl. F16K 31/12

(52) U.S. Cl. 206/509

(57) ABSTRACT

A propane gas tank carrier and storage apparatus includes a housing or shell having a base portion, and a top portion having a plurality of openings defining handles. The housing also includes an interior rim or other structure that facilitates stacking of another carrier atop the housing. The sides of the housing include nesting surface structure or topography that permits engagement of side-by-side shells so as to resist lateral and vertical movement when jostled. A hinge and fastener arrangement allows easy opening and secure closing of the shell halves around a propane tank.

### CROSS REFERENCE TO RELATED APPLICATIONS

The present application claims the benefit of the filing date of U.S. Provisional Patent Application, Ser. No. 60/459,236, filed 29 Mar. 2003.

### STATEMENT REGARDING FEDERALLY SPONSORED RESEARCH OR DEVELOPMENT

Not applicable.

### REFERENCE TO A MICROFICHE APPENDIX

Not applicable.

### TECHNICAL FIELD

The present invention relates generally to carrying devices, and more particularly to an improved stackable and protective propane gas tank carrier and storage apparatus.

### BACKGROUND INFORMATION AND DISCUSSION OF RELATED ART

Due to the regulatory and safety requirements which constrain their design, portable propane gas tanks are notoriously clumsy; they are difficult to carry and otherwise transport, and they are nearly impossible to stack vertically. Accordingly, it is known to provide a propane gas tank container apparatus that confines, secures, and in other ways seek to address the design limitations of the tanks themselves.

For instance, U.S. Pat. No. 6,042,130 to Souza, issued Mar. 28, 2000, discloses a carrier device for holding a container. The device includes a back member having top and bottom ends and a pair of sides extending between the top and bottom ends of the back member. The bottom end of the back member has a plurality of ground engaging members. Each of the sides of the back member has a pair of spaced apart belt slots and the back surface of the back member has a handle slot. The back end of the base member is pivotally coupled to the back member. The rear end of a top member is coupled to the back member with the forward end of the top member outwardly extending from the front surface of the back member. The forward end of the top member has a holding bracket which is downwardly extended from the lower face of the top member. This device is directed to providing a carrier suited for securing in an automobile or truck with a seat belt assembly.

U.S. Pat. No. 4,905,855 to Troiano et al., teaches a propane carry safe that includes a box-like housing having an open top, a foam packing insert with a central cylindrical aperture sized to fit into the open top of the housing so that the first aperture will receive the cylindrical body of a propane tank. The box is covered with a hinged top having an open bottom packed with foam which has a central cylindrical aperture that receives the propane tank valve assembly and valve protector when the cover is closed. The cover includes a latch. A handle is affixed to top of the cover. A set of securement straps are also provided at the sides of the housing to lock into seat belts in a motor vehicle.

U.S. Pat. No. 6,0122,411 to Hochbrueckner, shows a protective cover for a gas transport tank, having a cylindrical body, an upwardly extending valve, and a valve protection structure having a handle opening, the cover comprising a generally cylindrical drape portion; an upwardly extending enveloping portion, adapted to surround the upper valve protection structure of the tank and having an opening corresponding the handle opening, contiguous with the cylindrical drape portion; and an upper portion, inside the upwardly extending enveloping portion, having an aperture corresponding to a location of the upwardly extending valve, and allowing the valve to extend therethrough. The cover may include a business card holder flap, as well as an optional sensor system for determining liquid level in the tank and hazardous environmental gas levels.

The foregoing patents reflect the current state of the art of which the present inventor is aware. Reference to, and discussion of, these patents is intended to aid in discharging Applicant's acknowledged duty of candor in disclosing information that may be relevant to the examination of claims to the present invention. However, it is respectfully submitted that none of the above-indicated patents disclose, teach, suggest, show, or otherwise render obvious, either singly or when considered in combination, the invention described and claimed herein.

### BRIEF SUMMARY OF THE INVENTION

The propane gas tank carrier and storage apparatus of this invention includes a housing or shell having a base portion, and a top portion having a plurality of openings defining handles. The housing also includes an interior rim or other structure that facilitates stacking of another carrier atop the housing. The sides of the housing include nesting surface structure or topography that permits engagement of side-by-side shells so as to resist lateral and vertical movement when jostled. A hinge and fastener arrangement allows easy opening and secure closing of the shell halves around a propane tank.

The inventive propane gas tank carrier and storage apparatus provides an improved carrier apparatus especially well-suited for carrying, storing, and stacking propane gas tanks of the type conventionally used in a residential environment by end consumers, as well as protecting the tank from abrasion and corrosion. Such tanks typically comprise a cylindrical cannister or body, a valve assembly and a valve protector, and include tank carrying handles disposed on the top side of the cylindrical body.

It is therefore an object of the present invention to provide an improved propane gas tank carrier and storage apparatus that is inexpensive to manufacture, easy to ship and distribute, and that appeals to consumer interests, needs, tastes, and pocketbooks.

It is yet another object of the present invention to provide an improved propane gas tank carrier and storage apparatus that is fabricated of durable material.

It is still another object of the present invention to provide an improved propane gas tank carrier and storage apparatus that facilitates safe and easy transport of propane gas tanks.

Yet another object of the present invention is to provide an improved propane gas tank carrier and storage apparatus that includes structure to facilitate vertical and horizontal stacking of one container upon another, in rows and columns, so that the apparatus itself can be displayed for sales, and so that propane gas tanks can be safely stored in a space-economizing fashion.

Other novel features which are characteristic of the invention, as to organization and method of operation, together with further objects and advantages thereof will be better understood from the following description considered in connection with the accompanying drawing, in which preferred embodiments of the invention are illustrated by way of example. It is to be expressly understood, however, that the drawing is for illustration and description only and is not intended as a definition of the limits of the invention. The various features of novelty which characterize the invention are pointed out with particularity in the claims annexed to and forming part of this disclosure. The invention resides not in any one of these features taken alone, but rather in the particular combination of all of its structures for the functions specified.

There has thus been broadly outlined the more important features of the invention in order that the detailed description thereof that follows may be better understood, and in order that the present contribution to the art may be better appreciated. There are, of course, additional features of the invention that will be described hereinafter and which will form additional subject matter of the claims appended hereto. Those skilled in the art will appreciate that the conception upon which this disclosure is based readily may be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is neither intended to define the invention of this application, which is measured by the claims, nor is it intended to be limiting as to the scope of the invention in any way.

Certain terminology and derivations thereof may be used in the following description for convenience in reference only, and will not be limiting. For example, words such as “upward,” “downward,” “left,” and “right” would refer to directions in the drawings to which reference is made unless otherwise stated. Similarly, words such as “inward” and “outward” would refer to directions toward and away from, respectively, the geometric center of a device or area and designated parts thereof. References in the singular tense include the plural, and vice versa, unless otherwise noted.

### BRIEF DESCRIPTION OF THE SEVERAL VIEWS OF THE DRAWINGS

The invention will be better understood and objects other than those set forth above will become apparent when consideration is given to the following detailed description thereof. Such description makes reference to the annexed drawings wherein:

FIG. 1 is a perspective view of a plurality of the carriers of this invention in a stacked and nested arrangement;

FIG. 2 is a perspective view of a carrier apparatus of this invention in its open configuration for insertion or removal of a propane tank;

FIG. 3 is a top plan view of a carrier apparatus of this invention; and

FIG. 4 is a side elevation view in partial cross-section illustrating a first carrier apparatus stacked atop a second carrier apparatus.

### DETAILED DESCRIPTION OF THE INVENTION

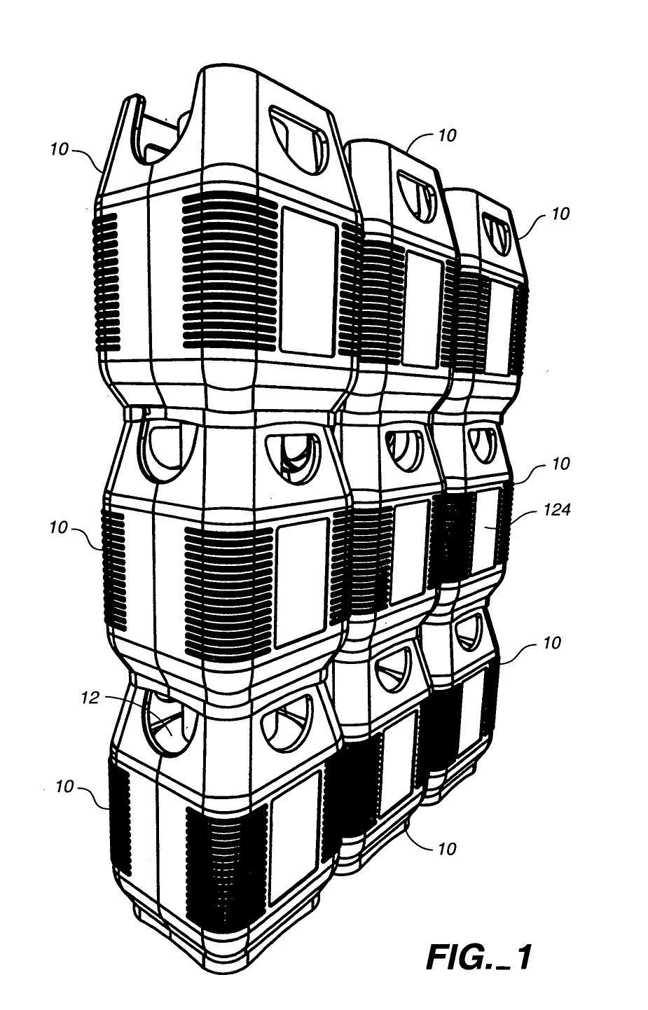

Referring to FIGS. 1 through 4, wherein like reference numerals refer to like components in the various views, there is illustrated therein a new and improved propane gas tank carrier and storage apparatus, generally denominated 10 herein.

Referring now to FIG. 1, a plurality of the improved propane gas tank carrier and storage apparatuses 10 are illustrated in a stacked and nested arrangement, each containing a propane tank 12 within. Vertical stacking and side-by-side nesting of the carriers is enabled by mating features on the surface of the shells, as described infra.

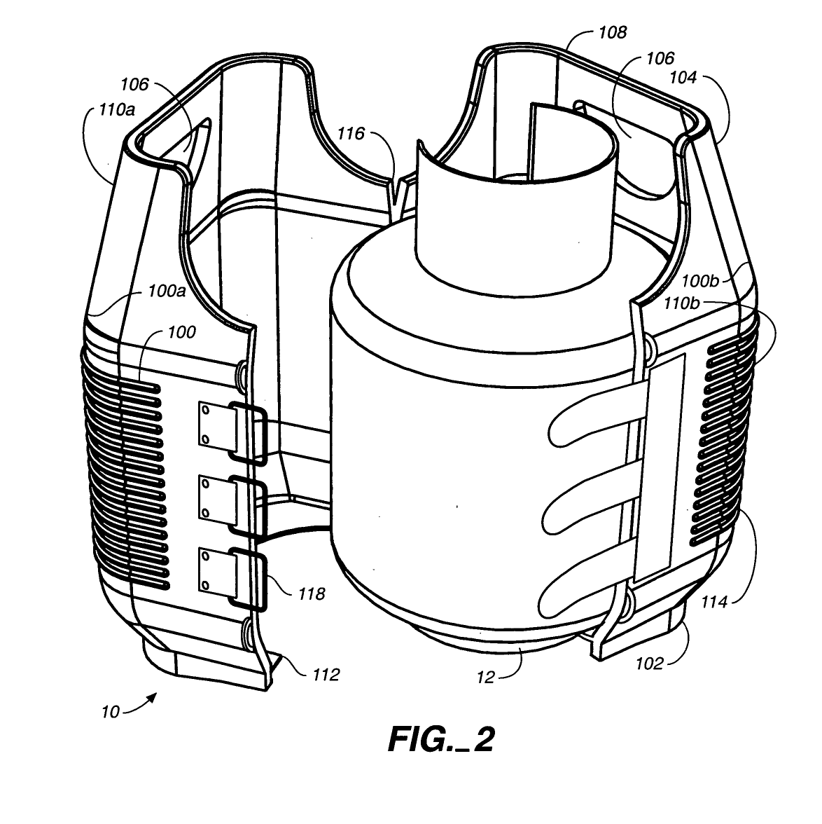

FIG. 2 is a perspective view of a single carrier apparatus 10 of this invention in its open configuration enveloping a propane tank 12. Carrier apparatus 10 includes a generally cuboid housing or shell 100 including shell halves 100a, 100b, respectively, and further having a base portion 102 (which may flare or extend outwardly for stability when placed on a surface), a top portion 104 having a plurality of openings 106 defining handles 108, and a plurality of side portions 110a, 110b. An interior rim 112 on the base portion 102 serves to engage the top portion of a carrier below it when they are stacked together. Alternatively, the stacking engagement could be achieved by an outwardly-extending rim or other feature. In a further alternate embodiment, the top portion may include an interior rim which functions as a support for the base of a carrier stacked upon it, or as a platform for a selectively removable stacking lid, or the top portion may include some other structural feature to enable stacking engagement with another carrier. The open nature of the top portion permits easy access to the tank valve assembly.

The housing of the preferred embodiment further includes lateral nesting surface structure or topography comprising a plurality of ribs 114, the rows of which are preferably staggered on opposing sides to permit matable approximation of adjoining shells in a vertically and horizontally stacked configuration for side-by-side positioning and storage. These ribs may further provide enhanced strength and resistance to damage or intrusion. Alternatively, the lateral nesting features may include a plurality of concavities or depressions matable with a plurality of compatibly placed convexities or protuberances. A hinge 116, preferably a living hinge, and a closure such as releasable buckles 118 allow easy enclosure of the shell 100 around a propane tank 12. Other types of hinges and/or closures may be used, as is well known in the art of containers.

The shell structure and nesting surface structure allows the apparatus to be stacked both vertically and horizontally in a secure configuration as depicted in FIG. 1. As an added marketing feature, a region of any one or more of the sides may be provided with a generally planar surface area 124 (FIG. 1) suitable for embossing or applying visual marketing materials, such as a company logo or trademark or other brand identity. The carrier apparatus itself may be constructed of plastic, metal, or any other suitable material, and may be designed to be mass-produced as by injection molding techniques.

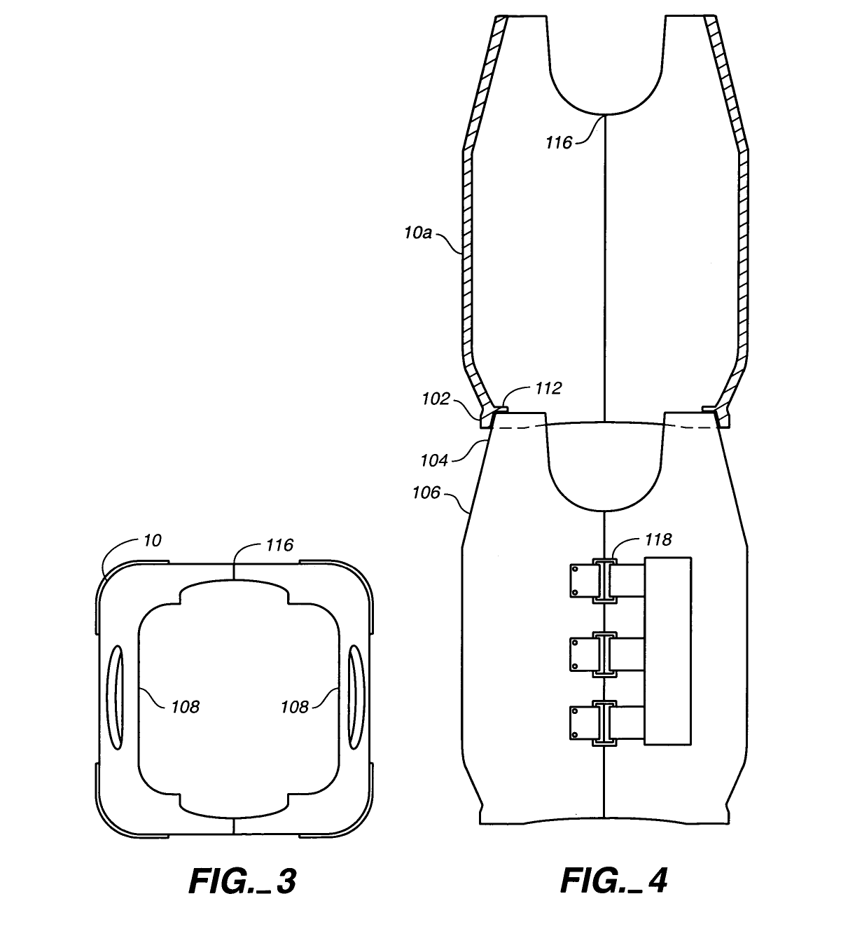

FIG. 3 is a top plan view of a carrier apparatus 10 of this invention, and FIG. 4 is a side elevation view in partial cross-section illustrating a first carrier apparatus 10a stacked atop a second carrier apparatus 10b. These views further illustrate the open nature of the top portion enabling easy access to a tank valve assembly carried within, and the vertical stacking ability of respective carriers.

As will be readily appreciated from the drawings, the housing 100 preferably tapers inwardly from all sides at the top portion 104, and then again at the bottom portion 102. This enhances both aesthetic features of the housing, and also increases its structural integrity when placed under loads.

Accordingly, the invention may be characterized as a carrier and storage apparatus for propane gas tanks comprising a shell member having a pair of shell halves, a base portion, a top portion, and a plurality of side portions; stacking means for engaging the base portion with the top portion of a shell member placed below; lateral nesting means for engaging at least one of the side portions with a side portion of an adjacent shell member; hinge means for opening the shell halves to enclose a gas tank; and fastener means for securing the shell halves together. Specifically, the top portion may include at least one opening defining a handle, the hinge means may comprise a living hinge, and the fastener means may comprise a releasable buckle. Furthermore, the stacking means may comprise an interior rim on the base portion, the lateral nesting means may comprise a surface structure on at least one of the side portions, such as a plurality of ribs, at least one of said side portions may include a generally planar surface area, and the shell member may taper inwardly from all sides at the top portion and/or the bottom portion.

The above disclosure is sufficient to enable one of ordinary skill in the art to practice the invention, and provides the best mode of practicing the invention presently contemplated by the inventor. While there is provided herein a full and complete disclosure of the preferred embodiments of this invention, it is not desired to limit the invention to the exact construction, dimensional relationships, and operation shown and described. Various modifications, alternative constructions, changes and equivalents will readily occur to those skilled in the art and may be employed, as suitable, without departing from the true spirit and scope of the invention. Such changes might involve alternative materials, components, structural arrangements, sizes, shapes, forms, functions, operational features or the like.

Therefore, the above description and illustrations should not be construed as limiting the scope of the invention, which is defined by the appended claims.

What is claimed as invention is:

1. A carrier and storage apparatus for propane gas tanks, said carrier and storage apparatus comprising:
a shell member having a pair of shell halves, a base portion, a top portion, and a plurality of side portions;
stacking means for engaging said base portion with the top portion of a shell member placed below;
lateral nesting means for engaging at least one of said side portions with a side portion of an adjacent shell member;
hinge means for opening said shell halves to enclose a gas tank; and
fastener means for securing said shell halves together.

2. The carrier and storage apparatus of claim 1 wherein said top portion includes at least one opening defining a handle.

3. The carrier and storage apparatus of claim 1 wherein said hinge means comprises a living hinge.

4. The carrier and storage apparatus of claim 1 wherein said fastener means comprises a releasable buckle.

5. The carrier and storage apparatus of claim 1 wherein said stacking means comprises an interior rim on said base portion.

6. The carrier and storage apparatus of claim 1 wherein said lateral nesting means comprises a surface structure on at least one of said side portions.

7. The carrier and storage apparatus of claim 1 wherein said lateral nesting means comprises a plurality of ribs on at least one of said side portions.

8. The carrier and storage apparatus of claim 1 wherein at least one of said side portions includes a generally planar surface area.

9. The carrier and storage apparatus of claim 1 wherein said shell member tapers inwardly from all sides at said top portion.

10. The carrier and storage apparatus of claim 1 wherein said shell member tapers inwardly from all sides at said base portion.
